(19) United States
(12) Patent Application Publication
(10) Pub. No.: US 2012/0085367 A1
(43) Pub. Date: Apr. 12, 2012

(54) Fiberglass Removal Pad and Method of Using

(76) Inventor: Jason D. Grimes, Searcy, AR (US)

(21) Appl. No.: 13/253,828

(22) Filed: Oct. 5, 2011

Related U.S. Application Data
(60) Provisional application No. 61/391,073, filed on Oct. 7, 2010.

(51) Int. Cl. A47L 13/16; B08B 1/00

(52) U.S. Cl. 134/6; 15/244.3

(57) ABSTRACT

A fiberglass removal pad comprising a sponge and a layer of nylon material, wherein said sponge is covered with said layer of nylon material. A method for using the fiberglass removal pad is also disclosed.

### CROSS-REFERENCE TO RELATED APPLICATIONS

This application claims the benefit of U.S. Provisional Application No. 61/391,073, entitled “Scratch and Itch Fiberglass Insulation Remover” and filed Oct. 7, 2010. The complete disclosure of said provisional patent application is hereby incorporated by reference.

### STATEMENT REGARDING FEDERALLY SPONSORED RESEARCH OR DEVELOPMENT

Not applicable

### BACKGROUND OF THE INVENTION

This invention relates to a fiberglass removal pad and, more particularly, to a fiberglass removal pad that is easily transportable and capable of being used on site where fiberglass insulation is being installed.

Fiberglass insulation is a construction material used for thermal insulation in buildings. It is made of extremely fine fibers of glass and is packaged in rolls that are installed along the walls and ceilings of buildings. During installation of the insulation, the small, brittle glass fibers from the insulation break off into a fine dust-like particulate that becomes airborne. Installers are commonly exposed to these small fragments of fiberglass which can cause irritation and discomfort to the exposed skin. Removal of the fibers becomes increasingly difficult as the fibers enter the much larger sized pores of the skin. The fibers tend to sink deeper when scratched.

The most common method for removing fiberglass from the skin consists of washing the skin with water and then wiping the skin with an ordinary bath towel. The inventor has observed that this method is not effective in completely removing the fiberglass from the skin. Some of the fibers remain on the skin until they are removed through the natural skin cell sloughing off process and other bodily processes. In addition, the installer may not have immediate access to water and a towel on the job site where the insulation is being installed. Therefore, the fibers may cause skin irritation before the installer has an opportunity to remove the fibers using the prior art method.

It therefore would be desirable to develop a pad for removal of fiberglass from the skin that is easily transportable and capable of being used on the job site.

### BRIEF SUMMARY OF THE INVENTION

The present invention is directed to a fiberglass removal pad comprising a sponge and a layer of nylon material, wherein said sponge is covered with said layer of nylon material.

The present invention is also directed to a method for removing fiberglass particles from the surface of the skin comprising rubbing the fiberglass removal pad described above across the surface of the skin.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of the preferred embodiment of the present invention.

FIG. 2 is a cross-section view of FIG. 1 of the preferred embodiment of the present invention.

### DETAILED DESCRIPTION OF THE INVENTION

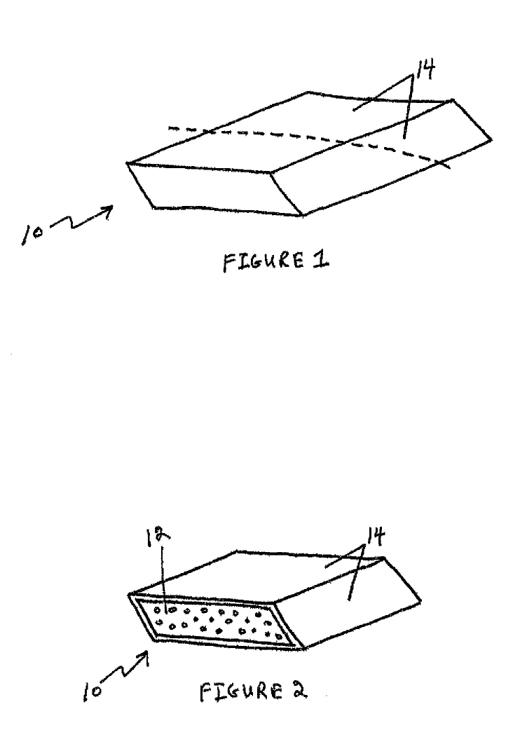

With reference to FIGS. 1-2, the preferred embodiments of the present invention may be described. The fiberglass removal pad 10 is comprised of a sponge 12 and a layer of nylon material 14. The sponge 12 is preferably rectangular in shape and at least 4 inches in length, 2.4 inches in height, and 0.6 inches in width.

The layer of nylon material 14 is preferably in the form of a sleeve with two open ends that receives the sponge 12. The two open ends of the layer of nylon material 14 corresponds to the two ends of said sponge 12. The open ends of the layer of nylon material 14 can be closed at one or both ends of the sponge 12. The layer of nylon material 14, therefore, can fully cover the sponge 12. The sponge 12 is soft and flexible which allows the pad 10 to contact the contours of the body when moved across the skin. While the sponge 12 is preferably used in the present invention, the pad 10 can instead be comprised of any other soft and flexible component capable of being received by the layer of nylon material 14.

The preferable means for closing the open ends of the layer of nylon material 14 is by stitching. The closing of the two open ends of the layer of nylon material 14 allows for the layer of nylon material to fit tightly over the surfaces of the sponge 12, thus aiding in the proper alignment and support for the fabric. This allows for more surface area of the fabric to contact the skin during the process of rubbing the pad 10 over the skin. The layer of nylon material 14 is thin and soft to the skin, similar to that of pantyhose. The layer of nylon material 14 of the pad 10 is durable and the inventor believes that the small and shallow pores of the nylon material 14 aids in the action of removing the fibers from the skin. In an alternative embodiment, the pad 10 is attached to a handle (not shown) at one end for easier use of the pad 10.

The pad 10 can be used to remove fiberglass particles from the skin of an installer of fiberglass insulation by sliding any surface of the pad 10 across the installer's skin. The inventor believes that the static electricity associated with the fiberglass particles aids in the removal of the particles after being contacted with the nylon fabric. Use of the pad 10 allows for immediate relief of skin irritation without the need for water. The compact size of the pad 10 also allows it to fit comfortably in a pocket of clothing for quick access.

The present invention has been described with reference to certain preferred and alternative embodiments that are intended to be exemplary only and not limiting to the full scope of the present invention as set forth in the appended claims.

We claim:

1. A fiberglass removal pad comprising a sponge and a layer of nylon material, wherein said sponge is covered with said layer of nylon material.

2. The fiberglass removal pad of claim 1 wherein said layer of nylon material comprises a first open end and a second open end.

3. The fiberglass removal pad of claim 2 wherein said first open end of said layer of nylon material is closed by stitching.

4. The fiberglass removal pad of claim 2 wherein said first open end of said layer of nylon material and said second open end of said layer of nylon material are closed by stitching.

5. The fiberglass removal pad of claim 1 wherein said sponge is completely covered with said layer of nylon material.

6. The fiberglass removal pad of claim 1 wherein said layer of nylon material is thin and soft.

7. A method for removing fiberglass particles from the surface of skin comprising rubbing the fiberglass removal pad of claim 1 across said surface of said skin.
